(19) United States
(12) Patent Application Publication
(10) Pub. No.: US 2024/0289556 A1
(43) Pub. Date: Aug. 29, 2024

(54) ACTIVE COMMUNICATION RECOMMENDATIONS

(71) Applicant: INTERNATIONAL BUSINESS MACHINES CORPORATION, ARMONK, NY (US)

(72) Inventors: TERRI VANESSA DILLON, COSTA MESA, CA (US); JEREMY R. FOX, AUSTIN, TX (US); ANDREW R. JONES, AUSTIN, TX (US); RAGHUVEER PRASAD NAGAR, BANGALORE (IN)

(21) Appl. No.: 18/175,845

(22) Filed: Feb. 28, 2023

(51) Int. Cl. G06F 40/35; H04L 51/21

(52) U.S. Cl. CPC G06F 40/35; H04L 51/21

(57) ABSTRACT

According to the computer-implemented method, an active communication between multiple users is identified. A context of the active communication is determined. Historical communications are searched for a similar context to the context of the active communication. The searched historical communications are analyzed for digital content that is relevant to the context. A recommendation is generated to use the digital content in the active communication based on the similar context.

### BACKGROUND

The present invention relates to active communication recommendations, and more specifically to generating recommendations for digital content to use in active communications.

### SUMMARY

According to an embodiment of the present invention, a computer-implemented method is described. According to the computer-implemented method, an active communication between multiple users is identified. A context of the active communication is determined. Historical communications are searched for a similar context to the context of the active communication. The searched historical communications are analyzed for digital content that is relevant to the context. A recommendation is generated to use the digital content in the active communication based on the similar context.

The present specification also describes a system. The system includes a processor having an associated memory. The associated memory contains instructions, which, when executed, cause the processor to: identify an active communication between a user and at least one additional participant; build a context of the active communication; search historical communications for a similar context to the context of the active communication; analyze the searched historical communications for digital content that is relevant to the context; generate a recommendation to use the digital content in the active communication based on the similar context; and present the recommendation and the context to the user.

The present specification also describes a computer program product for tracking an object of interest. The computer program product includes a computer readable storage medium having program instructions embodied therewith. The program instructions are executable by a processor, to cause the processor to identify an active communication between a user and at least one additional participant. The program instructions also cause the processor to determine that a response is expected from the user. The program instructions further cause the processor to build a context of the active communication. The program instructions additionally cause the processor to search historical communications for a similar context to the context of the active communication. The program instructions also cause the processor to analyze the searched historical communications for digital content that is relevant to the context. The program instructions further cause the processor to generate a recommendation to use the digital content in the active communication based on the similar context. The program instructions additionally cause the processor to present the recommendation and the context to the user. The program instructions also cause the processor to receive a user response to use the data in the active communication in response to the recommendation. The program instructions further cause the processor to provide the content to the at least one additional participant in the active communication in response to receiving the user response to use the data.

### BRIEF DESCRIPTION OF THE DRAWINGS

FIG. 1 depicts a computing environment for the execution of a computer-implemented method or application, according to an example of the principles described herein.

FIG. 2 depicts a flowchart of a method for generating digital content recommendations for use in active communications, according to an example of principles described herein.

FIG. 3 depicts a display for presenting a recommendation to use digital content, according to an example of the principles described herein.

FIG. 4 depicts a system for generating a recommendation to use digital content in an active communication, according to another example of principles described herein.

FIG. 5 depicts a computer program product with a computer readable storage medium for generating a recommendation to use digital content in an active communication, according to an example of principles described herein.

### DETAILED DESCRIPTION

Many times, while communicating with others using communication channels like email, instant messaging, text, telephone, social network, etc., users tend to discuss past events which and sometimes desire to share data which may have been shared in the past (some examples: old pictures, videos, messages, emails, social media posts, etc.). Even though the user has access to earlier shared content (pictures, videos, messages, emails, social media posts, etc.), it may be tedious to search for the content and then re-use the content once found. Which sometimes discourages the user from using earlier shared data points to make the conversation richer. Accordingly, the present specification describes systems and methods with which a user can receive a context sharing recommendation, based on the current context of the content sharing flow.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used in the present specification and in the appended claims, the term “a number of” or similar language is meant to be understood broadly as any positive number including 1 to infinity.

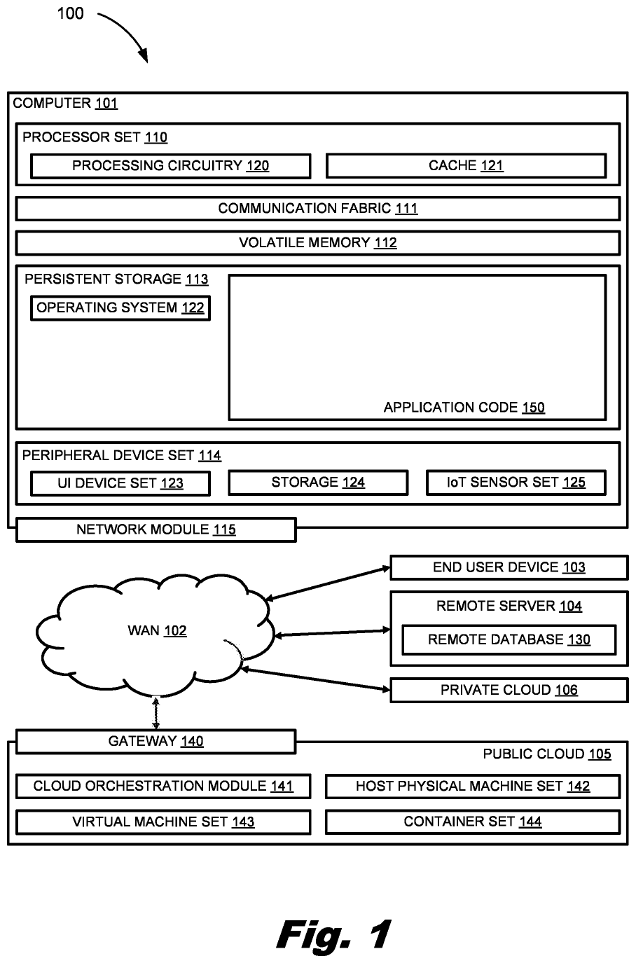

Turning now to the figures, FIG. 1 depicts a computing environment. Computing environment 100 contains an example of an environment for the execution of at least some of the computer code involved in performing the inventive methods include code 150 from which a user can receive a context sharing recommendation, based on the current context of the content sharing flow. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

The EUD 103 may be a client device operated by a producer of services or products that wants an analysis of available user data to ascertain user satisfaction. Operation of the EUD 103 for this objective will be described in further detail below.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

As described further below, the EUD 103 may use the network 102 to access an application on remote server 104. The application will access, again using the network 102, available user data. The application will then analyze the user data, with context specific analysis, to ascertain user satisfaction and generate recommendations for the producer based on the analysis.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, while communicating with others using communication channels like email, instant messaging, text, telephone, social network, etc., users may discuss past, current or future events. In some instances, a user may desire to share digital content in the active communication that has been shared in the past. As used herein the term “digital content” includes images, videos, messages (e.g., text messages), audio clips, emails, social media posts, or other digital data.

Even though the user has access to the earlier shared content, it may be tedious to search for the digital content and then re-use the content once found. The time and effort used to find the digital content may discourage the user from using the earlier shared digital content to make the conversation richer. Moreover, even if the user searches for the digital content, in some cases the digital content may not be relevant to the active communication. For example, a user may mistakenly search for a digital image that is unrelated to the active communication with a second participant.

Accordingly, the present specification relates to a user receiving a recommendation for using digital content in an active communication based on the current context of the active communication. The present specification describes examples of systems, methods, and computer program products for generating and presenting recommendations for using digital content in active communications.

In some examples, a system may generate digital content recommendations for an active communication context along with a rationale for the recommendations. In some examples, the recommendations can be formatted for digital media, such formatting including audio, video, or a text message. In a specific example, User A is having a discussion with friends B and C on a social media program, using a laptop computer. The active communication is about a vacation destination D. When B asks A if A has visited a location X at D, the system presents a picture of A at location X on a display of the laptop computer. The system asks for confirmation on sharing the picture with B and C. User A may then confirm sharing the picture or decline sharing the picture.

In some examples, the digital content recommendations may be based on historical data. For example, the historical data may be a user's data (e.g., photos, videos, text messages, etc.) or data shared between the user and the other participants. For example, the system may search social media conversations between the user and the other participants to identify relevant digital content. In some examples, the historical data may include publicly available data (e.g., information available on public internet sites).

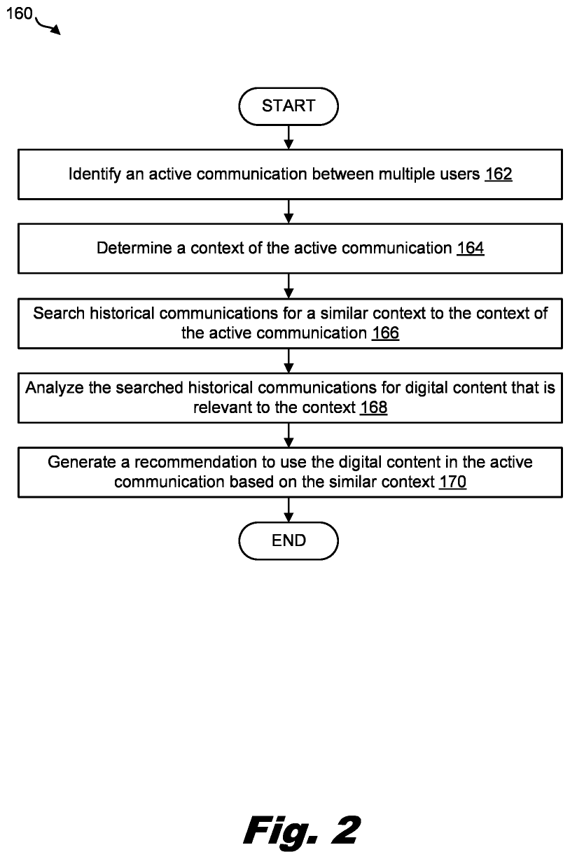

Turning now to the figures, FIG. 2 depicts a flowchart of a method 160 for generating digital content recommendations for use in active communications, according to an example of principles described herein. As described above, such a method 160 generates content recommendations for an active communication context along with a contextual identifier (e.g., rationale). In some examples, the context of the active communication includes the topic of the active communication. The present method 160 identifies relevant digital content and provides a recommendation to a user for presenting the digital content in the active communication. In some examples, the digital content recommendation may be presented to the user in a discrete manner such that other participants are unaware of the recommendation until the user elects to use the digital content.

According to the method 160, an active communication between multiple users is identified 162. For example, a system may run on a computing device used by a user. The system may include a recommendation engine to generate recommendations for content to use in active communications. As used herein, the term “engine” refers to a computing program (e.g., application, service, daemon, etc.) executed by a processor or a computing device. In some examples, the recommendation engine may run at the operating system layer. For instance, the recommendation engine may be a background service implemented by the operating system to monitor communications on the computing device. Some examples of communications include chat, email, text messages, social media posts, video conference communications, voice communications (e.g., phone call).

In some examples, the system may be implemented by a communication program. For instance, the system may be implemented by a text messaging program, social media program, video conferencing program, or other program used to communicate with other participants. In this scenario, the recommendation engine may be contained within the environment of the communication program.

In some examples, the active communication may be between a user and at least one other participant. For example, the user may communicate with a single other participant in a one-to-one chat session. In other examples, the user may communicate with multiple participants in a group communication.

The system may determine that the user is participating in an active communication based on a threshold condition. For example, the system may determine that the user is participating in an ongoing communication session (e.g., ongoing email thread, ongoing chat, call, etc.). In some examples, the system may determine that the user is participating in an active communication if the communication session continues for a threshold amount of time, or a threshold number of messages are exchanged between participants within a time frame.

In some examples, the method 160 may include determining if a response is expected from the user. For example, the system may use natural language processing (NLP) and/or speech processing to determine if a response is expected from the user. In some examples, the system may search within historical data (e.g., stored messages), publicly available data, the active communication (e.g., the current message) and/or media recommendations to determine the response expectation.

The method 160 also includes determining 164 a context of the active communication. The context may include the topic of the active communication. In some examples, the system may determine the context of the active communication using NLP and/or speech processing. For instance, the system may determine keywords in the active communication using NLP. In some examples, the system may build the context by using speech-to-text and further NLP from the active communication.

In some examples, the system may store the context along with the active communication in a database for future reference. For example, the system may tag the active communication with the context. The tagged communication may be stored in a searchable database.

Furthermore, the system may determine the context of the active communication based on historical data (e.g., chat history, etc.) and publicly available data (e.g., internet search results, related websites, etc.). For instance, the system may narrow the topic of the active communication by searching stored chat history. In another example, the system may determine the context of the active communication based on the participants (e.g., personal, family, friends, public, etc.).

The method 160 also includes searching historical communications 166 for a similar context to the context of the active communication. For example, the system may compare the built context of the active communication with the stored context of prior conversations. As described above 162 communications may be stored (e.g., in a database) with the built context to enable future searching of the communication by context.

In some examples, the scope of the active communication may be defined based on the type of communication and the participants to maintain the privacy of users. Therefore, the system may search public information and may avoid searching private information. For example, the type of social collaboration space may be defined, and historical content may be preserved for future usage. In an example, collaboration between participants may be considered public information. Thus, chat session materials may be deemed public. In another example, team-based emails may be deemed public. Messages within social media sites may be deemed public. Social media posts may be deemed public. Therefore, in some examples, searching the historical communications may include searching stored communications between the multiple users. Furthermore, searching the historical communications may include searching publicly available data (e.g., internet search results, related websites, etc.).

The method 160 also includes analyzing 168 the searched historical communications for digital content that is relevant to the context of the active communication. In some examples, the analyzing 168 may include identifying previously shared content relevant to the context. In some examples, digital content may be defined with a context. For example, metadata (e.g., tags) of digital content may provide a context of the digital content. The defined context of digital content may help the system understand why a piece of digital content is relevant to the active communication. In some examples, the context for a piece of digital content may be provided by metadata tagging of the digital content. In an example of contextual tagging to create metadata, a user has a personal vacation photo of the Grand Canyon from their last trip. The digital photo may be tagged with location and time metadata.

In some examples, the digital content may be tagged with metadata obtained through image processing. For example, the digital content may be scanned with optical object recognition software to aid within the overall tagging and filtering of the new and incoming content. In the example of the Grand Canyon photo, optical object recognition software may add the following tags to the metadata of the photo: “Outdoor photo,” “Grand Canyon,” “Clouds,” “Landscape,” “desert,” “vacation,” the physical location, the weather, “personal travel,” etc. These tags may be later utilized to search for the context of digital content for use in the active communication.

The system may search for previously built contexts from earlier conversations to see if any relevant context exist. Within the above example pertaining to the Grand Canyon, previous digital content has been collected and cataloged for searching. Upon identifying historical communications that have a similar context to the active communication, the system may analyze the tagged data of the digital assets included in the historical communications to identify digital content that is relevant to the active communication.

The system may query the historical communications for digital content that matches the context of the active communication. The system may search the digital content in the historical communications based on data tagging and metadata search filtering. This will allow the system to query digital content that is relevant to the context of the active communication. In an example, the photo of the Grand Canyon may be identified as relevant digital content that a user might find of interest in the active communication.

The method 160 also includes generating 170 a recommendation to use the digital content in the active communication based on the similar context. For example, once the system finds relevant digital content from the historical communications, the system may suggest to the user to use digital content in the active communication. For example, the system may present the recommendation to the user through a user interface that is unobservable by the other participants. For example, the system may present the recommendation in a display window of the user's computing device that is not observable by the other participants. In the example of the Grand Canyon photo, the system may recommend the Grand Canyon photo for re-use based on the context of the active communication. The user can accept or reject the Grand Canyon photo based on their own assessment for that piece of digital content.

In some examples, the system may synthesize the presentation of the recommendation and/or context. For example, the system may generate a text message audio, video, etc. that presents the recommendation and/or context to the user.

In some examples, the system may further present the context of the active communication along with the recommendation. For example, the system may display the built context with the recommendation in a manner that is observable by the user. The user may then assess context to determine the rationale for why the system is making the recommendation for the given digital asset. The user may determine whether the system has accurately identified the context of the active communication based on the presented context.

In some examples, the recommendation may include multiple items of digital content that are selectable by the user. For example, the system may detect multiple different items of digital content that are relevant to the active communication context. The system may present the multiple items of digital content based on relevance, with the most relevant digital content presented to the user first. The user may select one or more items of digital content to use in the active communication. For example, the user may scroll through multiple images to select the most relevant image.

In some examples, the user may choose to re-use the suggested digital content or may choose to ignore the recommendation based on discretion. In an example, the searching user may end up rejecting the initial recommended Grand Canyon photo suggested by the system. The searching user may scroll down to the next recommended image, which is another participant's digital image with similar tags. The searching user may like the second image, as the digital image had a higher value pertaining to the specific context that was being discussed.

In some examples, the method 160 may include receiving a user response to use the digital content in the active communication in response to the recommendation. For example, the user may select the recommended digital content for use in the active communication. The system may then provide the content to the multiple users in the active communication in response to receiving the user response to use the data. For example, the system may send to digital content to the other participants for presentation (e.g., graphical or audio presentation) on the devices of the other participants.

In some examples, the system may select a device to deliver the recommendation and context (e.g., rationale) to the user. For example, the system may select, based on a user experience threshold, the most appropriate user device (e.g., augmented reality (AR) glass, smartphone, etc.) to deliver the synthesized recommendations and context. In some examples, the device may be the same as the device used for the active communication. In some examples, the device may differ from the device used for the active communication. The user experience threshold may be predefined and/or determined based on device availability.

In some examples, the user experience threshold may be a user-defined trigger that the system uses to select a device to deliver the recommendation and/or context to the user. In some examples, the user experience threshold may be determined by crowdsourced triggering points that allow the content decision to be generated based on the overall user experience.

In some examples, as the system continues to store communications, the digital content can be scanned with optical object recognition software to aid within the overall tagging and filtering of the new and incoming digital content within this space. Ultimately, the produced context of the stored communications and digital content create a unique data lake that is relevant to the content that a user would care about. Therefore, the system may search data (e.g., stored communications and digital content) that is pertinent to the people, teams, and organizations in which the user works and/or associates. The described systems and methods provide for a personal tailoring of digital content. The data lake generated by the described systems and methods produces a collection of digital content that is relevant and pertinent to person usage. Thus, the described systems and methods supply data (e.g., communications and digital content) and metadata (e.g., the built context) that is pertinent to the specific scope of a user.

Some example scenarios of the described systems and methods are now presented. As described above, the system may generate recommendations for an active communication context where recommendations and the context (e.g., rationale) can be formatted for media, such as audio and video, or a text message. For instance, User A is having a discussion with friends B and C on a social media application, using a laptop. The discussion is on a vacation destination D. When B asks A if A has visited a spot X at D, the system, on A's AR glass, displays a picture of A at X and asks for confirmation on sharing the picture with B and C.

In another example scenario, the system generates recommendations for an active communication context, where the communication is based on text, speech, or gesture. For instance, user A is having a call with B on a first communication program. The discussion is on a vacation destination D. When B asks A if A has visited a spot X at D, the system, on A's AR glass, displays a picture of A at X and asks for confirmation on sharing with B over a second communication program (e.g., a text message program).

In another example scenario, the system generates recommendations for an active communication context where the recommendations and context identifiers are synthesized using historical data. For example, a group of friends visited a vacation spot a few years back, and friend A shared the pictures on a social network and in group chats. The system builds a context for this communication and stores the communication, the context, and the data shared. Later, user B among the group again visited the same vacation spot and shares pictures again on social networks and group chats. A discussion in the group happens for this event. The system works in the background and builds a context on what is being discussed. The system determines that the discussion is about the earlier context of a visit to same vacation spot. The system suggests to user B to re-share or re-use the conversations and digital content (e.g., text, pictures, video, audio) shared earlier.).

In another example scenario, the system may search publicly available data for digital content to use in the active communication. For example, user A is having a discussion on a social network, using a laptop, with friends B and C. The discussion is on a government policy. When B asks A if A likes the policy, the system, next to the message text box, displays a message recommending that A needs to be aware of the policy in answering the question.

In another example scenario, the system may generate recommendations for an active communication context where the search for recommendations and the context are optimized by searching data that is relevant to the context. For example, user A is having a discussion on a social network, using a laptop, with friends B and C. The discussion is on a vacation destination D. When B asks A if A has visited a spot X at D, the system only searches A's social network history. However, in another example, user A is having a discussion on a social network, with friends B and C. The discussion is on a government policy. When B asks A if A likes the policy, the system searches both the internet and A's social network history to find relevant information to use in the active communication.

In yet another example scenario, the system may generate recommendations for an active communication context where the system selects a device to deliver the recommendations based on a dynamically computed user experience threshold. For example, user A is having a discussion on a social network, using a laptop, with friends B and C. The discussion is on a vacation destination D. When B asks A if A has visited a spot X at D, the system displays on A's AR glass a picture of A at X and asks for confirmation on sharing with B and C. In another scenario, the system may display the picture next to the message box of the active communication.

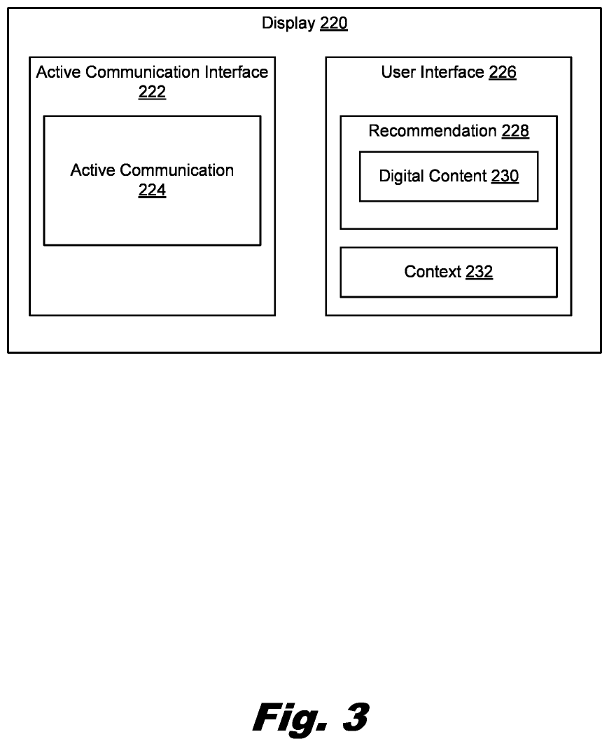

FIG. 3 depicts a display 220 for presenting a recommendation 228 to use digital content 230, according to an example of the principles described herein. In the example of FIG. 3, a system monitors the active communication 224 between a user and at least one additional participant. The active communication 224 is displayed in an active communication interface 222 of the display 220.

When the active communication 224 is initiated between the user and at least one additional participant, in the background the system builds and stores a context 232 of the active communication 224, as described in FIG. 2. Now whenever a new communication is initiated, the system may understand the context 232 of what is being discussed then intelligently searches historical communications (e.g., using artificial intelligence (AI), keyword matching, etc.) in the background if a similar context was built earlier. If the system finds a similar context in the historical communications, then the system may present a recommendation 228 to use digital content 230 from the historical communication in the active communication 224. In some examples, the digital content 230 may include pictures, videos, text message, emails, social media posts.

In the example of FIG. 3, the recommendation 228 is presented in a user interface 226 that is separate from the active communication 224. The system may include one or multiple items of digital content 230 that are relevant to the context 232. In some examples, the system may also present the context 232 to the user within the user interface 226.

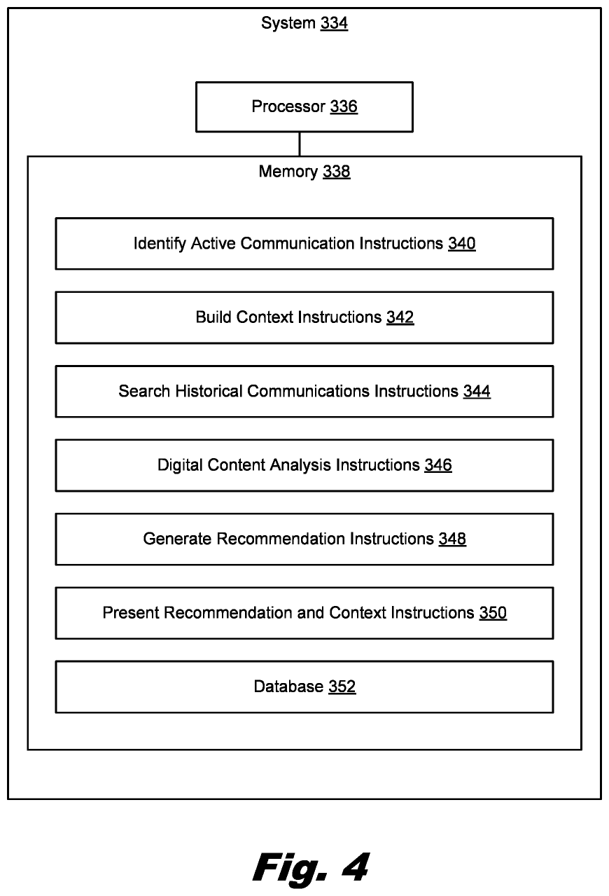

FIG. 4 depicts a system 334 for generating a recommendation to use digital content in an active communication, according to another example of principles described herein. To achieve its desired functionality, the system 334 includes various hardware components. Among these hardware components may be a number of processors 336, memory 338, a number of peripheral device adapters (not shown), and a number of network adapters (not shown). These hardware components may be interconnected through the use of a number of busses and/or network connections. In an example, the processor 336, memory 338, peripheral device adapters, and a network adapter may be communicatively coupled via a bus.

The processor 336 may include the hardware architecture to retrieve executable code from the memory 338 and execute the executable code. The executable code may, when executed by the processor 336, cause the processor 336 to provide a summary of a previously covered topic to a user joining a meeting. The functionality of the system 334 is in accordance to the methods of the present specification described herein. In the course of executing code, the processor 336 may receive input from and provide output to a number of the remaining hardware units.

The memory 338 may store data such as executable program code that is executed by the processor 336 and/or other processing device. The memory 338 may specifically store computer code representing a number of applications that the processor 336 executes to implement at least the functionality described herein.

The memory 338 may include various types of memory modules, including volatile and nonvolatile memory. For example, the memory 338 of the present example includes Random Access Memory (RAM), Read Only Memory (ROM), and Hard Disk Drive (HDD) memory. Other types of memory may also be utilized, and the present specification contemplates the use of many varying type(s) of memory in the memory 338 as may suit a particular application of the principles described herein. In certain examples, different types of memory in the memory 338 may be used for different data storage needs. For example, in certain examples the processor 336 may boot from ROM, maintain nonvolatile storage in the HDD memory, and execute program code stored in RAM.

The memory 338 may include a computer readable medium, a computer readable storage medium, or a non-transitory computer readable medium, among others. For example, the memory 338 may be, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The memory 338 includes a number of instructions (340, 342, 344, 346, 348, 350) for performing a designated function. The memory 338 causes the processor 336 to execute the designated function of the instructions (340, 342, 344, 346, 348, 350).

Referring to FIG. 4, identify active communication instructions 340, when executed by the processor 336, cause the processor 336 to identify an active communication between a user and at least one additional participant. Build context instructions 342, when executed by the processor 336, may cause the processor 336 to build a context of the active communication. Search historical communications instructions 344, when executed by the processor 336, may cause the processor 336 to search historical communications for a similar context to the context of the active communication. For example, the memory 338 may include a database 352 in which the historical communications are stored with the previously built contexts. In some examples, the instructions, which, when executed, further cause the processor 336 to determine the historical communications to search based on the context of the active communication. For example, the system 334 may narrow the historical communications searched based on the context of the active communication. In some examples, the historical communications may include prior communications between the user and the at least one additional participant. In some examples, the historical communications include publicly available data (e.g., data available on public internet sites).

Digital content analysis instructions 346, when executed by the processor 336, may cause the processor 336 to analyze the searched historical communications for digital content that is relevant to the context. In some examples, analyzing the searched historical communications for digital content that is relevant to the context includes comparing the context of the active communication to tagged metadata of the digital content.

Generate recommendation instructions 348, when executed by the processor 336, may cause the processor 336 to generate a recommendation to use the digital content in the active communication based on the similar context. Present recommendation and context instructions 350, when executed by the processor 336, may cause the processor 336 to present the recommendation and the context to the user. In some examples, the instructions, which, when executed, further cause the processor 336 to select a device to present the recommendation and the context to the user based on a user experience threshold. In some examples, the instructions, which, when executed, further cause the processor 336 to provide the digital content to the at least one additional participant in response to receiving a user response to use the digital content.

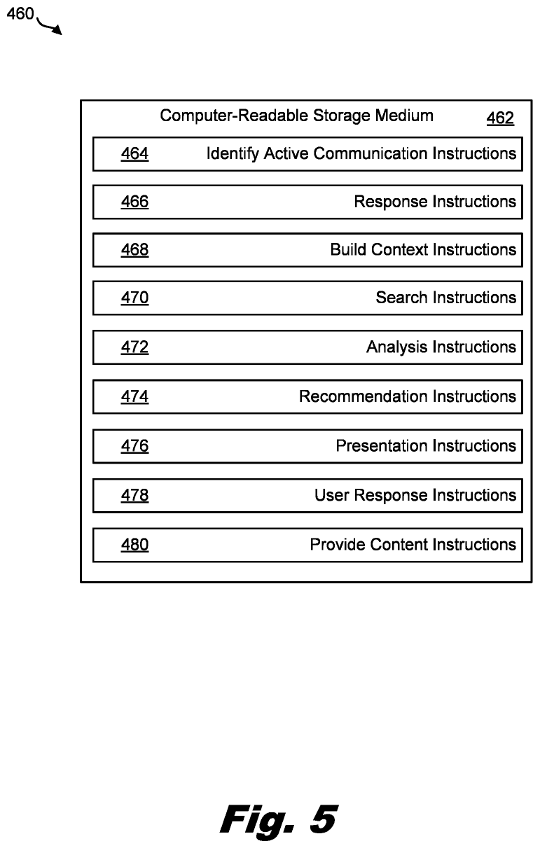

FIG. 5 depicts a computer program product 460 with a computer readable storage medium 462 for generating a recommendation to use digital content in an active communication, according to an example of principles described herein. To achieve its desired functionality, a computing system includes various hardware components. Specifically, a computing system includes a processor and a computer-readable storage medium 462. The computer-readable storage medium 462 is communicatively coupled to the processor. The computer-readable storage medium 462 includes a number of instructions (464, 466, 468, 470, 472, 474, 476, 478, 480) for performing a designated function. The computer-readable storage medium 462 causes the processor to execute the designated function of the instructions (464, 466, 468, 470, 472, 474, 476, 478, 480).

Referring to FIG. 5, identify active communication instructions 464, when executed by the processor, cause the processor to identify an active communication between a user and at least one additional participant. Response instructions 466, when executed by the processor, may cause the processor to determine that a response is expected from the user. The build context instructions 468 may cause the processor to build a context of the active communication. Search instructions 470, when executed by the processor, may cause the processor to search historical communications for a similar context to the context of the active communication. Analysis instructions 472, when executed by the processor, may cause the processor to analyze the searched historical communications for digital content that is relevant to the context.

Recommendation instructions 474, when executed by the processor, may cause the processor to generate a recommendation to use the digital content in the active communication based on the similar context. In some examples, the recommendation includes multiple items of digital content that are selectable by the user. Presentation instructions 476, when executed by the processor, may cause the processor to present the recommendation and the context to the user. In some examples, the recommendation and the context are presented to the user through a user interface that is unobservable by the least one additional participant.

User response instructions 478, when executed by the processor, may cause the processor to receive a user response to use the data in the active communication in response to the recommendation. Provide content instructions 480, when executed by the processor, may cause the processor to provide the content to the at least one additional participant in the active communication in response to receiving the user response to use the data.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. In one example, the computer usable program code may be embodied within a computer readable storage medium; the computer readable storage medium being part of the computer program product. In one example, the computer readable storage medium is a non-transitory computer readable medium.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying an active communication between multiple users;
determining a context of the active communication;
searching historical communications for a similar context to the context of the active communication;
analyzing the searched historical communications for digital content that is relevant to the context; and
generating a recommendation to use the digital content in the active communication based on the similar context.

2. The computer-implemented method of claim 1, wherein the context comprises a topic of the active communication.

3. The computer-implemented method of claim 1, wherein determining the context of the active communication comprises building the context using at least one of natural language processing and speech processing.

4. The computer-implemented method of claim 1, further comprising determining, using natural language processing, if a response is expected from a user.

5. The computer-implemented method of claim 1, wherein searching the historical communications comprises searching stored communications between the multiple users.

6. The computer-implemented method of claim 1, wherein searching the historical communications comprises searching publicly available data.

7. The computer-implemented method of claim 1, wherein the analyzing comprises identifying previously shared content relevant to the context.

8. The computer-implemented method of claim 1, further comprising presenting the context of the active communication along with the recommendation.

9. The computer-implemented method of claim 1, further comprising storing the active communication with the context in a database.

10. The computer-implemented method of claim 1, further comprising:
receiving a user response to use the digital content in the active communication in response to the recommendation; and
providing the content to the multiple users in the active communication in response to receiving the user response to use the data.

11. A system, comprising:
a processor having an associated memory, wherein the associated memory contains instructions, which, when executed, cause the processor to:
identify an active communication between a user and at least one additional participant;
build a context of the active communication;
search historical communications for a similar context to the context of the active communication;
analyze the searched historical communications for digital content that is relevant to the context;
generate a recommendation to use the digital content in the active communication based on the similar context; and
present the recommendation and the context to the user.

12. The system of claim 11, wherein the instructions, which, when executed, further cause the processor to select a device to present the recommendation and the context to the user based on a user experience threshold.

13. The system of claim 11, wherein the instructions, which, when executed, further cause the processor to determine the historical communications to search based on the context of the active communication.

14. The system of claim 13, wherein the historical communications comprise prior communications between the user and the at least one additional participant.

15. The system of claim 13, wherein the historical communications comprise publicly available data.

16. The system of claim 11, wherein the instructions, which, when executed, further cause the processor to provide the digital content to the at least one additional participant in response to receiving a user response to use the digital content.

17. The system of claim 11, wherein analyzing the searched historical communications for digital content that is relevant to the context comprises comparing the context to tagged metadata of the digital content.

18. A computer program product, the computer program product comprising a computer readable storage medium having program instructions embodied therewith, the program instructions executable by a processor, to cause the processor to:
identify an active communication between a user and at least one additional participant;
determine that a response is expected from the user;
build a context of the active communication;
search historical communications for a similar context to the context of the active communication;
analyze the searched historical communications for digital content that is relevant to the context;
generate a recommendation to use the digital content in the active communication based on the similar context;
present the recommendation and the context to the user;
receive a user response to use the data in the active communication in response to the recommendation; and
provide the content to the at least one additional participant in the active communication in response to receiving the user response to use the data.

19. The computer program product of claim 18, wherein the recommendation and the context are presented to the user through a user interface that is unobservable by the least one additional participant.

20. The computer program product of claim 18, wherein the recommendation comprises multiple items of digital content that are selectable by the user.
